(19) United States
(12) Patent Application Publication
(10) Pub. No.: US 2003/0110060 A1
(43) Pub. Date: Jun. 12, 2003

(54) Method of providing comprehensive drug compliance information

(76) Inventor: William A. Clementi, Bryn Mawr, PA (US)

Correspondence Address: David C. Jenkins, Eckert Seamans Cherin & Mellott, LLC, 600 Grant Street, 44th Floor, Pittsburgh, PA, 15219, US

(21) Appl. No.: 10/020,364

(22) Filed: Dec. 12, 2001

(51) Int. Cl. G06F 17/60

(52) U.S. Cl. 705/2

(57) ABSTRACT

A method is provided for encouraging patient compliance with a medicine regimen that includes interaction with the patient. The method includes the steps of providing a database which includes information regarding each patient. Information is supplied to the database by smart packages and other stakeholders. The information in the database is used to construct a patient report that may be viewed by the patient and others. Information in the patient report includes data on the patient's compliance, side effects of the medicine, expected results, interactions with other medicines, statements complimenting compliance, and warnings discouraging non-compliance. The patient report may be accessed by a common communication means such as the Internet.

### BACKGROUND OF THE INVENTION

1. Field of the Invention

This invention relates to methods of providing feedback to doctors, patients, care-givers, and drug manufactures regarding the compliance with a drug, exercise, and/or diet regimen or diagnostic testing by a patient and, more specifically, to a method that utilizes smart packages and the Internet to collect data regarding the compliance with such a regimen by a patient.

2. Background Information

The prevalence of the use of medicine in a modern society cannot be overstated. Medicines are used by persons of all ages to treat simple illnesses to life threatening diseases. Often, a variety of medications will be required to treat a single illness. Successful treatment of such medical conditions through the use of medication depends on the patient taking the prescribed dose of medication according to a prescribed schedule. Failure to comply with the prescribed schedule reduces the effectiveness of the medicine and may prolong the treatment and/or cause medical complications.

Patient compliance with a medical regimen is affected by many factors. Some patients will take a medicine only as long as the symptoms of an illness are present, for example, patients taking an antibiotic to combat a severe cold. Once the symptoms of the illness begin to fade, but before the end of the medical regimen, the patient stops taking the medicine and allows the illness to reemerge. Another factors in patient compliance include the memory of the patient. That is, factors such as the intensity of the illness, age, and side effects of the medication, may cause a patient to forget the dosage schedule. Additionally, some patients do not like to take certain medicines because of their side effects or even because of their taste.

There are various means of encouraging a patient to comply with a medical regimen. For example, packages for medicines contain a printed instruction indicating a prescribed or recommended dosage and interval between doses. More advanced packages include electronic alarms that indicate when a dose should be taken. A patient may also subscribe to a service that will send an electronic reminder, i.e. by pager or by e-mail, when it is time to take a dose. In certain instances, a patient may be hospitalized so that his or her medication can be monitored.

These methods are not always effective and/or efficient. Patients may not read a package label or may not hear an alarm on a package. Just as patients forget to take their medicine, a patient may forget to carry a beeper or check e-mail. Hospitalization is both expensive and inconvenient for the patient. Additionally, other than hospitalization, these methods do not provide feedback to the patient, to the patient's doctor, or other interested stakeholders, such as care-givers, regarding the compliance level of a patient.

There is, therefore, a need for a method of encouraging and sustaining patient compliance with a medical regimen that provides feedback to a patient and other stakeholders.

There is a further need for a method of encouraging patient compliance with a medical regimen that includes repeated interaction with the patient to encourage compliance.

There is a further need for a method of encouraging patient compliance with a medical regimen that includes incentives beyond a reminder to take a dose of medicine.

There is a further need for a method of disseminating information to various stakeholders regarding the compliance of a patient with a medical regimen.

### SUMMARY OF THE INVENTION

These needs, and others, are satisfied by the invention which provides a method of encouraging patient compliance with a medicine regimen that includes interaction with the patient and may be used to provide financial incentives to promote compliance. The method includes the steps of providing a database which includes information regarding each patient. Information is supplied to the database by smart packages (described below) and other stakeholders. The information in the database is used to construct a patient report that may be viewed by the patient and others. Information in the patient report includes data on the patient's compliance, time remaining in the regimen, side effects of the medicine, expected results, interactions with other medicines, statements complimenting compliance, and warnings discouraging non-compliance. The patient report may be accessed by a common communication means such as the Internet.

Smart packages, such as those disclosed in U.S. patent application Ser. No. 09/776,983 include electronic memory devices, typically a computer chip, that can be programmed with information relating to a medicine and a patient. For example, information may include the patient's name and other basic personal information, identification of the drug, the prescribed or recommended dosage, and other such pertinent data. Smart packages also passively record information as to when the package was opened and closed. The opening of a package indicates, but does not verify, that the medication was taken. This information is transmitted through a communication medium, such as the Internet, to the database. Providing information regarding the opening and closing of the package is an on-going process.

Additional information, for example, interactions between medicines, known side effects, costs of alternative medicines, expected results of a medicine regimen, and dosage changes can be added to the database by other stakeholders such as doctors, health care providers, medicine manufactures, and insurance companies. Additional data can be generated by doctors upon examination of a patient. This data can include recommendations for a diet and exercise regimen or observations about the patient and opinions as to whether the patient is complying with the medicine regimen. Further, the patient report may include a form, or similar device, that allows the patient to provide feedback to the database. All of the information collected can be combined with the data from a patient's smart package to prepare the patient report.

After data is gathered from the various stakeholders, the database can construct a patient report that includes data such as basic personal information, a record of all medicines being used, interactions between the medicines, side effects of the medicine, and the expected result. A patient can access this information and receive immediate feedback regarding his or her status. Moreover, data supplied by the smart package and by a doctor's opinion as to whether a patient is complying with the medicine regimen can be displayed. This information can be used to perform a calculation of the performance level of the patient which can be displayed alpha-numerically. For example, if the patient is taking the medicine, the feedback would include encouragement to continue. If the patient is not taking the medicine, a warning may be displayed describing the adverse consequences.

While interaction and feedback will encourage greater compliance with a medicine regimen, encouragement can also be a result of a financial reward or penalty. The data used to generate the patient report can also be used to generate a compliance-behavior value for each patient. The compliance-behavior value can be used as a factor in determining a patient's insurance rates, co-payment, or what medicines a patient may be approved for. For example, a recalcitrant patient who rarely complies with a medicine regimen may simply have his insurance rates increased, not unlike a bad driver who has multiple accidents. Data on another patient may reveal that she complies with a medical regimen that includes pills taken once a day, but not a medical regimen that includes pills taken four times a day. Thus, this patient would have a lower insurance rate if she agrees to optimize her medicine regimen by using once-a-day medications whenever possible.

### BRIEF DESCRIPTION OF THE DRAWINGS

A full understanding of the invention can be gained from the following description of the preferred embodiments when read in conjunction with the accompanying drawings in which:

FIG. 1 is a schematic view of the stakeholders and there interaction.

FIG. 2 is a flow chart showing the steps of the method.

### DESCRIPTION OF THE PREFERRED EMBODIMENTS

As used herein, “medicine” includes both prescription and non-prescription pharmaceutical products, vitamins, minerals, steroids, and drugs in any form, including, but not limited to, pills, liquids, tablets, inhaleable mists, injectable fluids, eye drops, cremes, powders, capsules, caplets, other oral dose forms, and topical medications.

As used herein, “patient” includes the person who uses a medicine as well as aids, nurses, health care practitioners and other medical personnel or assistants who help the person.

As used herein, “stakeholder” includes the patient, doctors, healthcare givers, insurance companies, manufacturers of medicines, and providers of medicines and others interested in a patient's compliance with a medicine regimen.

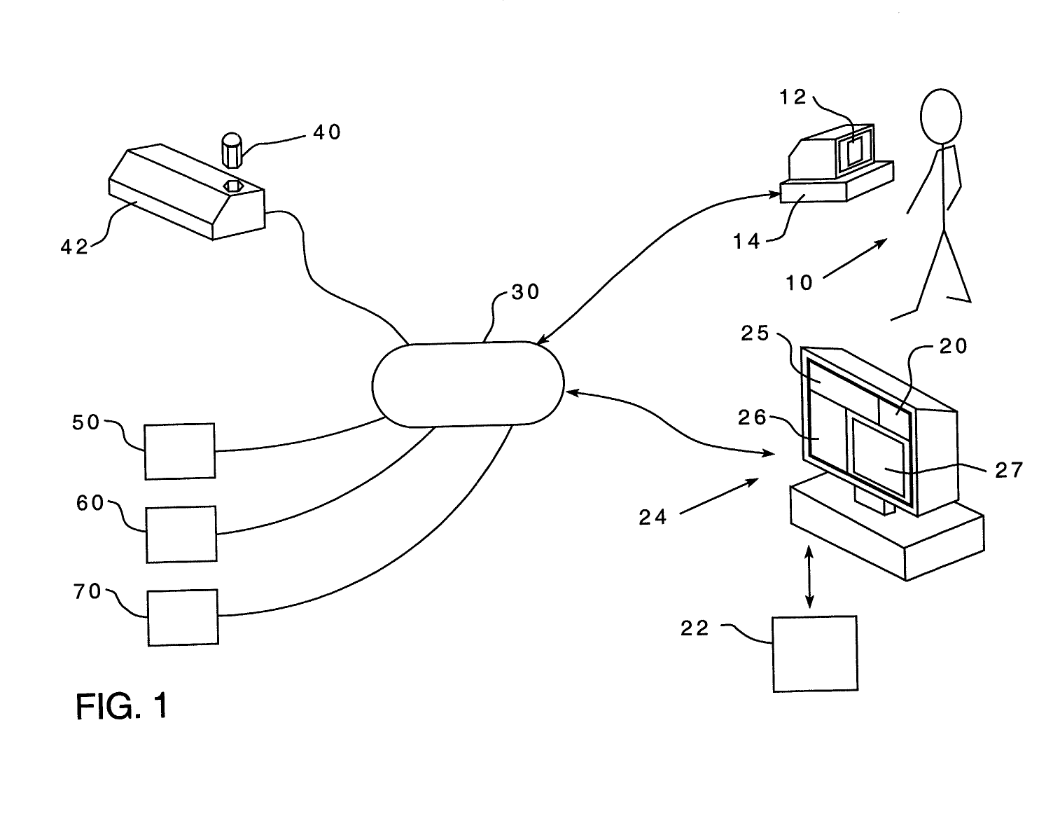

As shown in FIG. 1, the method for improving patient compliance with a medicine regimen includes providing the patient 10 with feedback, preferably in the form of a patient report 12. The patient report 12 is generated by a computer program interacting with a database 20 operated by an administrator 22. The database 20 is located on a first computer 24 operated by the administrator 22. The database 20 includes a component to store data 25, a component to analyze data 26 and a component to generate a patient report 27. The component to store data 25 stores the data as an electronic data structure. As used hereinafter, “database” includes the raw data contained in the database 20 as well as the software used to manipulate the data in the database 20. Each patient 10 who uses the database 20 will have an account in the database 20. This account may be protected by a password to prevent unauthorized persons from viewing the patient's account. The patient 10 accesses the database 20 through an electronic communications medium, such as the Internet 30, using a second computer 14 or other Internet appliance. The patient 10, however, cannot alter the database 20 information regarding compliance once a record is started.

Data is provided to the database 20 by various sources and stakeholders 10, 40, 50, 60, 70. One source of data is a smart package 40. A smart package 40 includes an electronic memory device (not shown), such as a computer chip, that can be programmed with information relating to a medicine and a patient 10. Pertinent information includes the patient's name and other basic personal information, identification of the medicine, the prescribed or recommended dosage, and time between doses. The smart package 40 also records information as to when the package 40 was opened and closed. The smart package 40 is structured to cooperate with a base unit 42 that contains a communication device such as a modem (not shown). Thus, the base unit 42 can transmit data from the smart package 40 through a communication medium, such as the Internet 30, to the database 20. Each time the patient 10 places the smart package 40 in the base unit 42, data is transmitted to the database 20. Thus, the smart package providing information regarding the opening and closing of the smart package 40 is an ongoing process.

The database 20 is also structured to receive data from the patient 10 in addition to data from the smart package 40. The patient can access the database 20 through the Internet 30. The database 20 will provide the patient 10 with an electronic feedback form which the patient may fill out. The form may provide multiple choice questions, answers to which can be quickly analyzed by the database 20, or provide for the patient 10 to give a narrative response.

The database 20 also receives data from the makers of medicines 50 regarding additional information about the medicine, such as side effects, effectiveness, and interactions between medicines. The makers of medicines 50 can access the database 20 through a communication medium, such as the Internet 30. Thus, as new information is developed, the database 20 can be updated quickly.

Additional information for each patient 10 is provided by the patient's doctor 60. The doctor 60 can also identify what medicines have been prescribed or recommended along with the dosage amount and frequency. A doctor 60 also provides his or her subjective input regarding the patient's compliance with a medicine regimen. Whereas the smart package 40 records when the package was opened and closed, thus indicating compliance, a recalcitrant patient 10 may simply not take the medicine. Alternatively, a patient 10 may place multiple doses of a medicine in another container, e.g. a smaller bottle for travel, and the smart package 40 will report non-compliance. In these instances, a doctor 60 may input data reflecting his or her subjective opinion regarding the patient's compliance. Additionally, the doctor 60 may change the dosage for a patient 10, input additional data such as a diet regimen or exercise regimen, and input the results of other diagnostic tests, e.g. blood work. Doctors 60 can access the database 20 through a communication medium, such as the Internet 30.

Information and data may also be provided by insurance companies or HMOs 70. Insurance companies 70 provide information relating to their own coverage and the costs of various medicines. An insurance company 70 can access the database 20 through a communication medium, such as the Internet 30.

The database 20 is structured to collect data from the smart packages 40 and the various stakeholders 10, 50, 60, 70. The database 20 then analyzes the raw data to provide an output relevant to each stakeholder 10, 50, 60, 70. For example, the patient 10 may access the patient report 12 which includes basic personal information, a record of all medicines being used, interactions between the medicines, side effects of the medicine, and the expected result. Moreover, data supplied by the smart package 40 and by a doctor's opinion as to whether a patient 10 is complying with the medicine regimen can be displayed as a compliance level. The compliance level can be represented by various means including, but not limited to, a percentage, a number on a scale between one and ten, or, in the case of children (under adult supervision) a happy face or a sad face. Thus, if the patient 10 is taking the medicine, the patient report would reflect that fact and encouragement the patient to continue. If the patient 10 is not taking the medicine, a warning may be displayed describing the adverse consequences.

Stakeholders other than the patient 50, 60, 70 receive reports tailored to their needs. For example, and insurer 70, who is interested in risk analysis, does not require information on drug interactions but requires the information regarding compliance. The insurer 70 analyzes the compliance data to determine a compliance behavior value. The compliance behavior value may be calculated by a statistcal model, similar to models used to calculate automobile or home insurance rates. The compliance behavior value may be represented various ways. For example, the compliance behavior value may be a simple number on a scale from one to ten, e.g. a one represents poor compliance and a ten represents perfect compliance. The compliance behavior value may also be a code. That is, the compliance behavior value may be a multi-digit number where each digit represents compliance with a particular type of medicine. For example, a simple two digit code where the first digit represents a patient's compliance taking pills and the second digit represents the patient's compliance taking liquid medicine. Thus, a patient who complies well while taking pills but not so well while taking a liquid medicine would have a code such as “92.” Here the “9” represents a high compliance while taking pills and the “2” represents poor compliance while taking liquids. This code can be expanded to many digits to represent many different categories and characters may be used to represent special information.

The compliance behavior value is used as a factor in setting the patients insurance rate or to determine other coverage factors, e.g. the amount of the patient's deductible or co-payment. The compliance behavior value is reported to the patient 10 as part of the patient report 12. Thus, the patient 10 receives feedback showing him or her the financial benefit or detriment of their own compliance. Proper compliance will result in a lowering of insurance costs, while poor compliance will increase a patient's insurance costs. The compliance behavior value is adjusted over time in response to the patient's changing rate of compliance.

### EXAMPLE

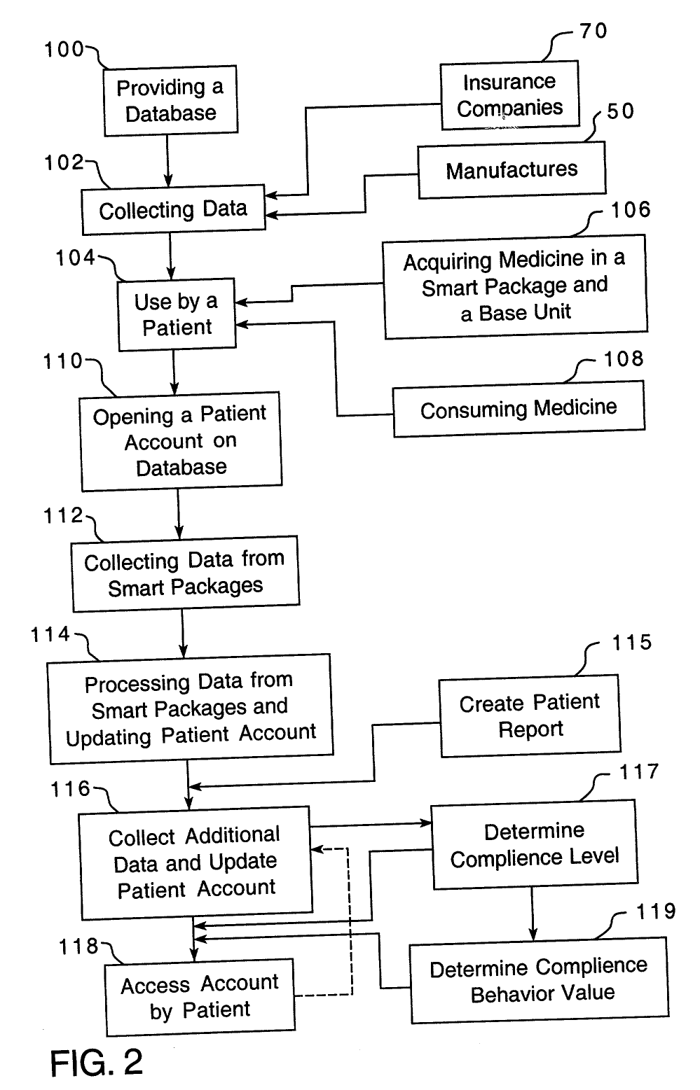

As shown in the flow chart on FIG. 2, prior to initiating use by a patient 10, the administrator 22 provides 100 the database 20 and collects data 102 from manufactures 50 and insurance companies 70 as described above. Use by a patient 10 begins when the patient uses 104 medicines A, B, and C. These medicines may have been prescribed by a doctor 60 or may be over the counter medicines, or a combination thereof. Medicine A is a pill taken once a day, medicine B is a pill taken three times a day and medicine C is administered as liquid eye drops twice a day. Use by a patient 104 includes both providing 106 the patient 10 the medicine in a smart packages 40 and a base unit 42, and consuming 108 the medicine. The smart packages 40 are programmed with data as detailed above. The patient 10 is also advised how to use the smart packages 40. When the smart packages 40 are given to the patient 10, the administrator 22 is so advised and account on in the database 20 is opened 110.

When the patient 10 first uses the smart package 40 and base unit 42, data from the smart package 40 is collected 112. Data from the smart packages 40 travels through the base unit 42 and the Internet to the database 20. The database 20 processes the data from the smart package 114, and, more specifically, the patient's account is updated to indicate what medicines are being used. The database 20 processes the data and provides information to the patient's account regarding side effects of each medicine, interactions between the medicines, and other such information as detailed above. This information is used to create 115 a patient report. The patient 10 may use a second computer 14 to access her account and view the patient report 12. At this point in time, the patient 10 does not have a compliance level or compliance behavior value.

For the sake of this example, the patient 10 is a bad patient; she only takes her medicines once a day. Additionally, she does not care for the eye drops because of a mild side effect and, after a short time, stops taking medicine C altogether. These actions, with the limitations noted above, are reported by smart packages 40. Periodically, e.g. typically once an hour, or as often as technology allows, the database 20 collects and stores additional data, analyzes the patient's actions and updates her account 116. During this time, the database 20, by analyzing the data, determines the compliance level 117 for each patient. This data can also be used to determine a compliance behavior value 119. When a doctor 60 checks on the patient's progress, the doctor will be alerted to the non-compliance and may contact the patient 10 to encourage compliance or to schedule an examination. The insurance company 70 will also be alerted to the non-compliance and will update the patient's account with a warning that the patient's insurance rates will increase.

When the patient 10 next accesses her account 118, the patient report 12 will indicate her non-compliance and the consequences thereof. Under scrutiny of her doctor and the threat of increased insurance rates, the patient 10 begins to comply with the medicine regimen. After a time, however, her dislike of the eye drops causes her to stop taking medicine C again. These actions are again recorded by the smart packages 40 and the collected data supplied 116 to the database 20. Additionally, the patient provides a comment to the account indicating her dislike of the eye drops because of the mild side effect. When the patient 10 visits the doctor 60 and the account is again viewed by the doctor 60, the doctor 60 can see the noncompliance relative to medicine C as well as the patient's comments. The doctor 60 also notes the patient's preference for once-a-day pills, and may select a medicine that fits this preference. Thus, the doctor 60 prescribes another medicine, medicine D, a once-a-day pill, to replace medicine C.

The patient 10 now substantially complies with the medical regimens. A record of the patient's compliance is generated by the smart packages 40, as well as by comments from the doctor 60, and stored on the database 20. Now, the patient's compliance behavior value improves and the insurance company 70 advises the patient that her rates will be lowered. Having received positive reinforcement, the patient's compliance continues to improve. Additionally, the mild side effect which may have not been noticed in the testing of the medicine is noted. The drug manufacturer 50 may receive a number of such reports and note the side effect in a future product warning.

While specific embodiments of the invention have been described in detail, it will be appreciated by those skilled in the art that various modifications and alternatives to those details could be developed in light of the overall teachings of the disclosure. For example, the patient account can be set up at any time and by any person. Thus, and insurance company 70 may set up an account for each insured and encourage the insured to use the smart packages 40 to receive lower rates. Accordingly, the particular arrangements disclosed are meant to be illustrative only and not limiting as to the scope of invention which is to be given the full breadth of the claims appended and any and all equivalents thereof.

What is claimed is:

1. A method of disseminating medical information to increase patient compliance with a medical regimen, said method comprising the steps of:
a) creating a database which includes information regarding a plurality of patients and a plurality of medicines;
b) providing a system structured to allow a plurality of stakeholders to access said database and input data into said database through an electronic communication medium;
c) collecting input data from said stakeholders in said database through an electronic communication medium;
d) providing medicine to a patient in a smart package;
e) providing a device structured to allow said smart packages to interact with said database through an electronic communication medium;
f) collecting data from said smart packages and storing said data in said database;
g) analyzing data to determine the compliance level of the patient;
h) creating a patient report for each said patient having data relevant to each said patient; and
j) allowing each said patient to access his or her patient report through an electronic communication medium.

2. The method of claim 1, wherein said data input by said stakeholders includes data regarding the side effects of a medicine and interactions between medicines.

3. The method of claim 2, wherein said data input by said stakeholders includes data regarding at least one of: the expected results from a medicine, diagnostic medical test results on a patient, data regarding the adherence to exercise, or diet regimens by a patient.

4. The method of claim 1, wherein:
a) said step of collecting data from said smart packages is an on-going process and said analysis to determine a compliance level is repeated periodically; and
b) said step of creating a patient report is repeated periodically.

5. The method of claim 1, comprising the further steps of:
a) analyzing data to determine a compliance-behavior value of the patient; and
b) allowing a stakeholder access the compliance-behavior value for a specific patient through an electronic communication medium.

6. The method of claim 5, wherein said step of analyzing data to compliance-behavior value includes the steps of:
a) formulating a recursive algorithm;
b) comparing the data regarding a patient with a pre-defined set of optimal criteria; and
c) adjusting the patient's compliance-behavior value as the patient's compliance improves or declines.

7. The method of claim 5 wherein said step of analyzing data to determine a compliance-behavior value includes the step reducing the compliance behavior value to a number or a code.

8. The method of claim 5, wherein said stakeholders are selected from the group including patients, doctors, insurance companies, pharmaceutical companies, pharmaceutical distributors, and healthcare providers.

9. The method of claim 8 further comprising the steps of:
a) said insurance company providing said patient with insurance at a rate;
b) said insurance company adjusting said rate for a patient based on said patient's compliance-behavior value; and
c) updating said patient report with information about said adjustment in said rate.

10. The method of claim 1, wherein said stakeholders include patients, doctors, insurance companies, pharmaceutical companies, pharmaceutical distributors, and healthcare providers.

11. A computer-readable medium structured to communicate with smart packages for medicines and a plurality of stakeholders through an electronic medium, and containing instructions for determining the compliance of a patient with a medicine regimen, by:
a) storing a database which includes information regarding a plurality of patients and a plurality of medicines;
b) collecting input data from said stakeholders through said electronic communication medium;
c) collecting data from said smart packages and storing said data in said database; and
d) analyzing data to determine the compliance level of the patient.

12. The computer-readable medium of claim 11, wherein said data collected from said stakeholders includes data regarding the side effects of a medicine, interactions between medicines, and the expected results of medicines.

13. The computer-readable medium of claim 12, wherein said data collected from said stakeholders includes data regarding diagnostic medical test results, and data regarding the adherence to exercise and diet regimens by a patient.

14. The computer-readable medium of claim 11, wherein:
a) said step of collecting data from said smart packages is an on-going process and said analysis to determine a compliance level is repeated over time; and
b) said step of analyzing data to determine the compliance level of the patient is repeated over time.

15. The computer-readable medium of claim 11, comprising further instructions for:
a) analyzing data to determine a compliance-behavior value of the patient; and
b) allowing a stakeholder access the compliance-behavior value for a specific patient through an electronic communication medium.

16. A computer-readable medium containing a data structure for storing data relating to the compliance of a patient with a medicine regimen containing data relating to a plurality of medicines and an account for each of a plurality of patients, each account containing data identifying the medicines being taken by each a patient and the data identifying when a smart package that contains the medicine is used.

17. The computer-readable medium containing a data structure of claim 16 wherein said patient account further includes data input by a doctor regarding compliance by a patient.

18. A system for disseminating medical information to increase patient compliance with a drug regimen comprising:
a computer controlled by an administrator; a component storing a database which includes information regarding a plurality of patients and a plurality of medicines;
a means for a plurality of stakeholders to access said database and input data into said database through an electronic communication medium;
a means for recording input data from said stakeholders in said database through an electronic communication medium;
a smart package for storing medicine;
a means for said smart packages to interact with said database through an electronic communication medium;
a means for collecting data from said smart packages and storing said data in said database;
a data analyzing component that analyzes said data from said smart packages to determine the compliance level of the patient;
a patient report generating component that creates a patient report for each said patient, said patient report having data relevant to each said patient; and
a means for allowing each said patient to access his or her patient report through an electronic communication medium.

19. The system of claim 18 wherein said computer controlled by an administrator includes said component storing a database, said data analyzing component, and said patient report generating component.

20. The system of claim 18 wherein said means for collecting data from said smart packages is a base station.

21. The system of claim 18 wherein said means for allowing each said patient to access his or her patient report is a computer.
